(19) United States
(12) Patent Application Publication
(10) Pub. No.: US 2012/0091124 A1
(43) Pub. Date: Apr. 19, 2012

(54) CONTAINER INCLUDING SURFACE FEATURES FOR LIMITING CONDUCTIVE HEAT TRANSFER

(76) Inventors: Evan T. Frisch, Mount Laurel, NJ (US); Robert D. Burnard, Cherry Hill, NJ (US)

(21) Appl. No.: 13/026,879

(22) Filed: Feb. 14, 2011

Related U.S. Application Data
(63) Continuation-in-part of application No. 29/377,255, filed on Oct. 19, 2010.

(51) Int. Cl. H05B 6/80

(52) U.S. Cl. 219/725; 220/592.01

(57) ABSTRACT

Disclosed is an exemplary container having surface features for limiting heat transfer between the contents of the container and a person with whom the container comes in contact. The container may include an interior region for receiving a substance and at least one wall defining the interior region. The wall may include an outer surface and an opposite inner surface disposed between the outer surface and the interior region of the container. The wall further includes a first thermal conduction path extending between the inner and outer surfaces of the wall, and a second thermal conduction path arranged adjacent the first thermal conduction path and extending between the inner and outer surfaces of the wall. The first thermal conduction path has a higher effective thermal conductivity than the second thermal conduction path.

### CROSS-REFERENCE TO RELATED APPLICATIONS

This application is a continuation-in-part of U.S. application Ser. No. 29/377,255, filed on Oct. 19, 2010, which is hereby incorporated in its entirety.

### BACKGROUND

Containers are used throughout the food industry to store and transport a variety of products. They come in a multitude of shapes and sizes, and may be made from a variety of materials. Depending on the particular product, the container may be required to withstand multiple heating and cooling cycles. Certain commercial and consumer food products may require the container contents to be heated to a suggested temperature prior to serving. Not only does the heating process heat the contents of the container, but may also cause the container to reach temperatures that may be uncomfortable to touch, thereby requiring the user to utilize additional protection to comfortably grasp and hold the heated container. Attempts to overcome this limitation have been met with limited success.

### BRIEF DESCRIPTION OF THE DRAWINGS

FIG. 1 is a schematic perspective view of an exemplary container including surface features for limiting conductive heat transfer through a wall of the container;

FIG. 2 is a schematic front perspective view of the container;

FIG. 3 is a schematic rear perspective view of the container;

FIG. 4A is a schematic partial cross-sectional view of a wall of the container shown in FIG. 1;

FIG. 4B is a schematic partial cross-sectional view of an alternately configured wall of the container shown in FIG. 1;

FIG. 5 is a schematic partial cross-sectional view of the container wall illustrating operation of the heat transfer limiting surface features;

FIG. 6 is a schematic side view of the container employing an outer material layer arranged adjacent the surface features for limiting conductive heat transfer; and

FIG. 7 is a schematic partial cross-sectional view of a wall of the container shown in FIG. 6.

FIG. 8 is a flow chart depicting an exemplary method of heating a substance present within an interior region of the container.

### DETAILED DESCRIPTION

Referring now to the discussion that follows and the drawings, illustrative approaches to the disclosed systems and methods are described in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive, otherwise limit, or restrict the claims to the precise forms and configurations shown in the drawings and disclosed in the following detailed description.

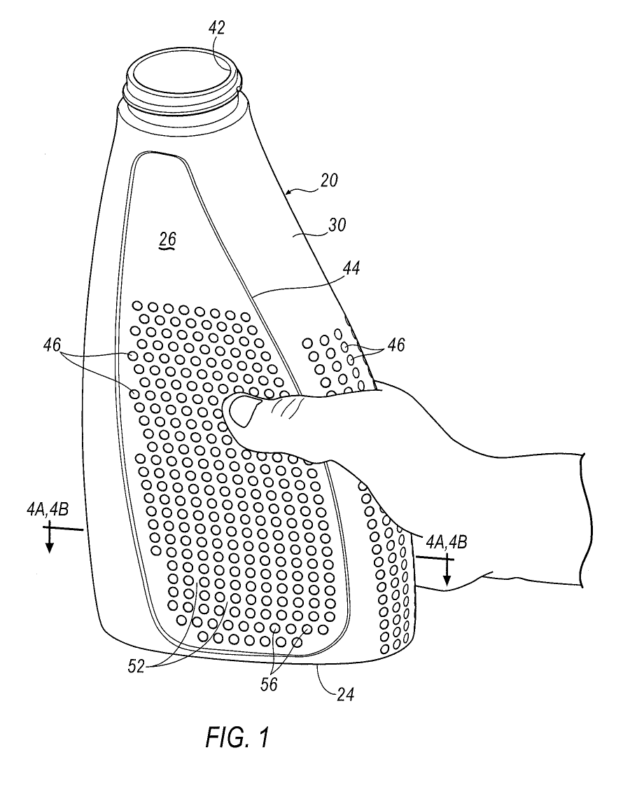

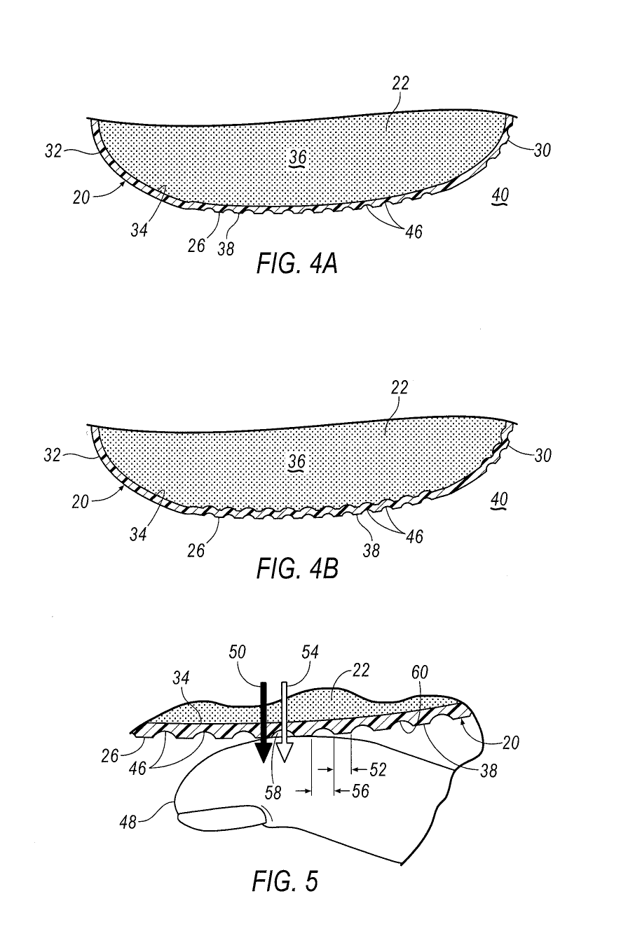

FIG. 1 illustrates an exemplary container 20 for holding a substance 22 (see FIGS. 4A, 4B and 7), which may include a solid, liquid, gas, powder, gel, as well as other substances. Container 20 may be constructed from any of a variety of materials, including but not limited to, glass, plastic, ceramic, metal, composites, and combinations thereof. The contents of container 20 (i.e., substance 22) may be subject to multiple heating and cooling cycles when in use. The selected materials should be capable of withstanding a generally broad range of temperatures and temperature gradients that may occur within the selected materials during successive heating and cooling cycles without undergoing significant material changes that may adversely affect the performance of container 20. Various heating apparatuses may be employed to heat substance 22, including but not limited to, a microwave oven. The materials selected to make container 20 should be compatible with the heating apparatus used to heat substance 22. For example, materials suitable for microwave heating may include polypropylene, high density polyethylene, polyethylene terephthalate (PET, APET, CPET), polystyrene, and poly lactic acid. Container 20 may be formed using any of a variety of manufacturing techniques, for example, injection molding and blow molding. Container 20 may be made entirely from a single material, or from a combination of materials, depending in part of the performance and aesthetic requirements of a particular application.

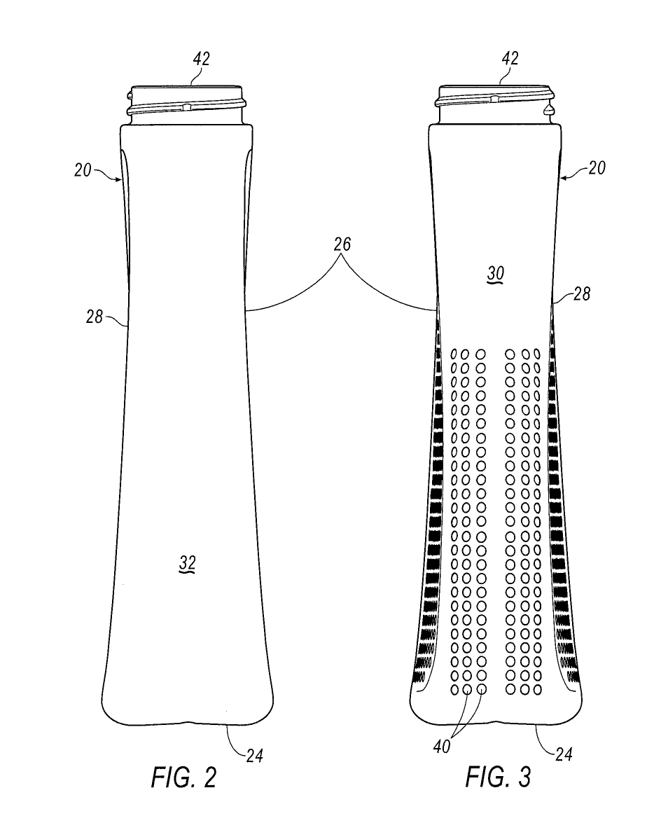

Container 20 may include various shapes and sizes to accommodate the aesthetic and functional aspects of a particular application. An exemplary configuration of container 20 is shown in FIGS. 1-4B. Container 20 may include a bottom 24; a first sidewall 26; a second sidewall 28 arranged opposite first sidewall 26; a first endwall 30 adjoining bottom 24 and first and second sidewalls 26 and 28; and a second endwall 32 arranged opposite first endwall 30 and adjoining bottom 24 and first and second sidewalls 26 and 28. With particular reference to FIGS. 4A and 4B, sidewalls 26 and 28, endwalls 30 and 32, and bottom 24, each include an inner surface 34 that at least partially defines an interior region 36 of container 20 for receiving substance 22, and an opposite outer surface 38 that at least partially defines an outer region 40. Container 20 may include an opening 42 for providing access to interior region 36 of the container. Substance 22 may be transported to and from container 20 through opening 42. Container 20 may further include one or more features to facilitate grasping and holding the container, such as for example, a generally concave region 44 that may be arranged on one or both sidewalls 26 and 28 in an area a user may tend to grasp when holding the container. Endwall 30 may be provided with a convex radius to enable the container to rest reasonably comfortably within the user's hand.

As noted previously, container 20 may be used to hold a variety of materials and substances. Certain materials and substances may require heating to activate or enable a particular property or characteristic of the substance. For example, the contents of container 20 may be in a semi-solid or viscous state at room temperature, but may transition to a liquid state upon heating, thereby allowing easier dispensing of the contents. The temperature required to achieve a desired consistency, however, may be sufficiently high to make grasping and holding the container uncomfortable. To reduce the perceived temperature of container 20, as sensed by a person when grasping the container, one or more recessed pockets 46 may be arranged on outside surface 38 of container 20. Recessed pockets 46 may be positioned in areas that tend to be grasped by the user when holding container 20. For example, recessed pockets 46 may be arranged within concave region 44 of first and second sidewalls 26 and 28 that contact the user's fingers, and along first endwall 30 that may contact a user's palm. Recessed pockets 46 may also be arranged in other areas of container 20 that may contact a user, and not just the user's hand.

Referring to FIGS. 4A and 5, recessed pockets 46 operate to limit a perceived temperature of container 20, but not necessarily an actual temperature of the container, by reducing a rate of heat transfer occurring between substance 22 contained within container 20 and portions of a person's anatomy contacting outer surface 38, such as finger 48. The “perceived temperature” sensed by the person when contacting container 20 may be different then the container's actual temperature. This may be partially explained by the fact that humans tend to perceive temperature based on the rate at which heat is dissipated from the person's anatomy. Generally speaking, a higher rate of heat loss will be perceived as corresponding to a colder temperature, whereas a lower rate of heat loss will generally be perceived as corresponding to a warmer temperature. This is the reason why a block of steel feels colder to the touch than a block of wood at the same temperature. Steel typically has a higher thermal conductivity than wood, which generally results in a higher rate of heat loss from the person's anatomy when contacting the steel block than occurs when contacting the wood block. The person perceives the steel block as having a colder temperature than the wood block due to the higher rate of heat loss to the steal block, even though both are at the same temperature. Recessed pockets 46 operate to reduce the perceived temperature of container 20 by reducing the rate of heat transfer from substance 22 contained within container 20 to a person's anatomy when contacting the container.

With particular reference to FIG. 5, pockets 46 tend to reduce the overall conductive heat transfer rate from container 20 to a person's anatomy, by creating intermittent air pockets 58 between outer surface 38 of container 20 and the person's anatomy when contacting the container. Recessed pockets 46 effectively create two conduction paths across the container wall (i.e., first sidewall 26 in FIGS. 4A-5) from inside surface 34 to outer surface 38, each conduction path having a different effective thermal conductivity. The term “effective thermal conductivity”, as used herein, refers to a combined thermal conductivity occurring across a thermal conduction path consisting of one or more materials, each of which may have a different thermal conductivity. For example, the “effective thermal conductivity” across a thermal conduction path consisting of a single material would be the same as the thermal conductivity of the material. The “effective thermal conductivity” of a thermal conduction path consisting of multiple materials having differing thermal conductivities will consist of a weighted average of the thermal conductivities of the individual materials.

With continued reference to FIG. 5, a first conduction path 50, identified by a thick solid arrow in FIG. 5, conducts heat from substance 22 to finger 48, which is in direct contact with outer surface 38 of the container wall. First conduction path 50 traverses the wall of container 20 within a first conduction region 52 located between recessed pockets 46. A second conduction path 54, identified by a thick outlined arrow in FIG. 5, conducts heat from substance 22 to finger 48 by successively transferring the heat first through first wall 26 and then through air pockets 58. Second conduction path 54 traverses the wall of container 20 within a second conduction region 56 substantially corresponding to recessed pockets 46. The container walls in the region of first and second thermal conduction paths 50 and 54 may be formed from a single generally uniform material. Recessed pockets 46 and finger 48 (or another region of the person's anatomy contacting container 20) together define air pockets 58. Unlike first conduction path 50, in which finger 48 directly contacts outer surface 38 of the container wall, there is substantially no contact between outer surface 38 and finger 48 in the region of recessed pockets 46.

First conduction path 50 has a higher effective conductivity than second conduction path 54. This is due to air having a lower thermal conductivity than most materials used to make container 20. For example, the thermal conductivity of air at room temperature is approximately 0.014 BTU/(ft-hr-° F.), whereas the thermal conductivity of a plastic, such as polypropylene, which may be suitable for high temperature applications, ranges between 0.0579-0.1274 BTU/(ft-hr-° F.). The low thermal conductivity of air (as compared to the thermal conductivity of plastic) results in significantly less heat being transferred from heated substance 22 to finger 48 along second conduction path 54 than occurs along first conduction path 50. This results in an overall reduction in the heat transfer rate between substance 22 and finger 48, as compared to a configuration in which recessed pockets 46 are not used. The person touching container 20 perceives the reduced heat transfer as corresponding to a lower container temperature.

With continued reference to FIG. 5, the reduction in the overall heat transfer rate between substance 22 and a person's anatomy (i.e., finger 48), is dependent on maintaining air pocket 58 between outer surface 38 of container 20 and the person's anatomy. Sizing recessed pockets 46 to large may allow a portion of finger 48 to contact a bottom surface 60 of recessed pocket 46 when holding the container, thereby increasing the heat transfer rate between substance 22 and finger 48. The person would likely perceive the increased heat transfer as corresponding to a higher container temperature. To minimize the chance of the undesirable temperature perception from occurring, recessed pockets 46 may be sized small enough to prevent finger 48 from contacting bottom surface 60 of the recessed pockets when grasping the container. In practice, the actual size of recessed pockets 46 may be dependent on a variety of factors, including but not limited to, a grip pressure required to securely grasp and hold container 20. Generally, a higher grip pressure may result in finger 48 protruding further into recessed pockets 46, thereby increasing the chance that the finger may contact bottom surface 60, which would reduce or eliminate the insulating effect of air pocket 58. This may be avoided by reducing the size of recessed pocket 46, and/or increasing its depth. A recessed pocket having a maximum dimension, as measured substantially in a plane of outer surface 38, of approximately 1/16 inch (approximately 0.16 cm) is generally sufficient to prevent finger 48 from contacting bottom surface 60 of recessed pocket 46.

The material used to manufacture container 20 may include material properties that tend to limit heating of container 20 when subjected to a particular heating method. For example, the selected material may exhibit a low thermal conductivity relative to substance 20, which may operate to impede the transfer of heat from substance 22 to container 20. The selected material may also be less susceptible to the heating effects of a particular heating method than substance 22. This may result in substance 22 reaching a higher maximum temperature than container 20 for a given energy input. For example, various solid materials such as certain glass and plastic materials are difficult to heat using microwaves, whereas substance 22 may more readily absorb energy from the microwaves, thereby causing a substance 22 to achieve a higher temperature than container 20.

With reference to FIGS. 4A and 4B, inner surface 34 of container 20 may have any of a variety of contours, which may depend, at least in part, on the manufacturing process used to produce container 20. For example, FIG. 4A shows inner surface 34 having a contour that generally corresponds to the general overall shape of container 20. Alternatively, FIG. 4B shows an inner surface 34 including a secondary contour that generally mirrors a contour of outer surface 38. These are merely two examples of the various surface contours that may be employed with interior surface 34. Other contours may also be utilized.

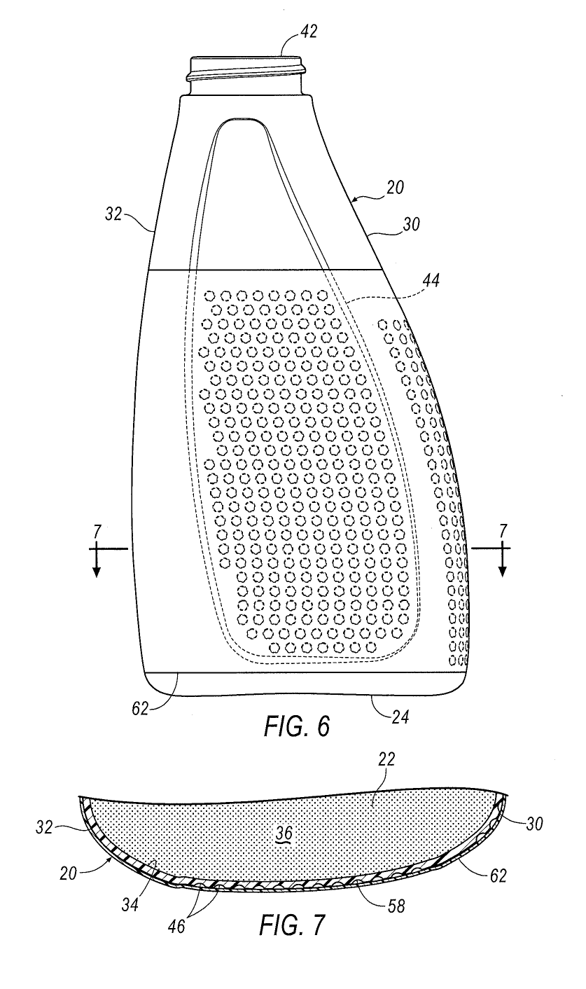

Referring to FIGS. 6 and 7, container 20 may include an outer material layer 62 arranged adjacent outer surface 38 of container 20. Outer material layer 62 may cover the entire outer surface of container 20, or any portion thereof. Outer material layer 62 may include, for example, a product label. Outer layer 62 may be made from a variety of materials, including but not limited to, paper, plastic, metal, and combinations thereof. Outer layer 62 may be arranged on outer surface 38 of container 20 so as to not substantially extend into recessed pockets 46, thereby maintaining at least some of the insulating benefits air pockets 58.

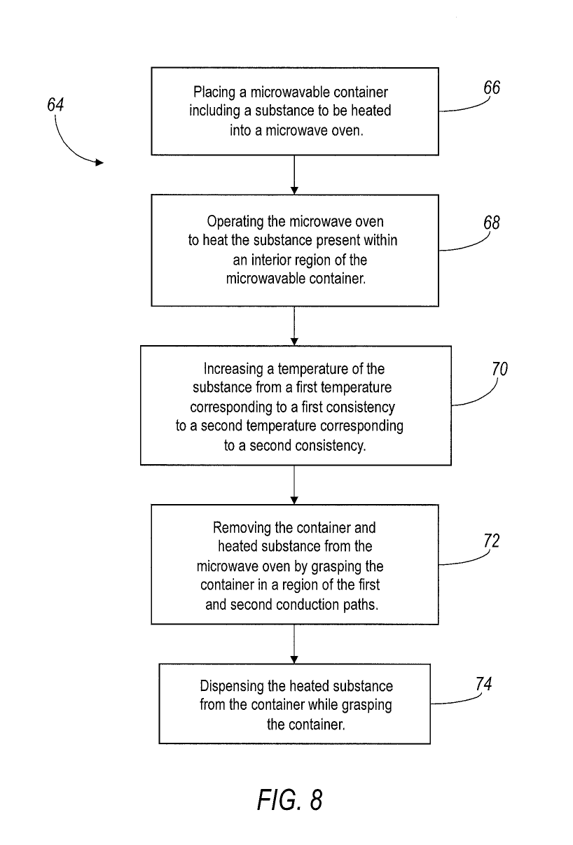

Substance 22 contained within container 20 may be heated using a variety of apparatus and methods. An example of one such heating method 64 using a microwave oven is described in FIG. 8. For this particular example, container 20 may be constructed from any of a variety of materials compatible with microwave heating. Other heating apparatus and methods may require that different materials be employed. The heating process may be used to reduce a viscosity of substance 22 to enable the substance to be more readily dispensed from container 20. For example, the consistency of substance 22 may be more viscous at room temperature than when heated to an elevated temperature. The consistency of substance 22 at room temperature may make dispensing substance 22 more difficult. Heating substance 22 to an elevated temperature above room temperature may reduce the viscosity of substance 22 to a consistency that may be easier to dispense.

Substance 22 may be heated to an elevated temperature by placing container 20, including substance 22, into a microwave oven at 66 of heating method 64. The microwave oven may be operated at 68 of heating method 64 to heat substance 22 to an elevated temperature. At 70 of heating method 64, a temperature of substance 22 may be increased from a first temperature, generally occurring prior to commencing the heating process, to a second elevated temperature occurring in response to the heating process. This causes a change in the consistency of substance 22, such that the viscosity of substance 22 at the first temperature is higher than the viscosity of substance 22 at the second elevated temperature. The lower viscosity of substance 22 at the second elevated temperature enables the substance to be readily dispensed from container 20.

Container 20, including heated substance 22, may be removed from the microwave oven by grasping container 22 along first and second thermal conduction regions 52 and 56 (see FIGS. 1 and 5). The lower thermal conductivity occurring within second thermal conduction path 54 relative to thermal conductivity occurring along first thermal conduction path 50 causes a person holding container 20 to perceive the temperature of outer surface 38 to be less than the actual temperature. This is due at least in part to a reduction in the amount of heat being transferred from heated substance 22 to the person as a result of the lower thermal conductivity occurring along second thermal conduction path 54. Substance 22 may be dispensed from container 22 at 74 of heating method 64 while continuing to grasp the container.

It will be appreciated that the exemplary container described herein has broad applications. The foregoing configurations were chosen and described in order to illustrate principles of the methods and apparatuses as well as some practical applications. The preceding description enables others skilled in the art to utilize methods and apparatuses in various configurations and with various modifications as are suited to the particular use contemplated. In accordance with the provisions of the patent statutes, the principles and modes of operation of the disclosed container have been explained and illustrated in exemplary configurations.

It is intended that the scope of the present methods and apparatuses be defined by the following claims. However, it must be understood that the disclosed container may be practiced otherwise than is specifically explained and illustrated without departing from its spirit or scope. It should be understood by those skilled in the art that various alternatives to the configuration described herein may be employed in practicing the claims without departing from the spirit and scope as defined in the following claims. The scope of the disclosed container should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future examples. Furthermore, all terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary. It is intended that the following claims define the scope of the device and that the method and apparatus within the scope of these claims and their equivalents be covered thereby. In sum, it should be understood that the device is capable of modification and variation and is limited only by the following claims.

What is claimed is:

1. A container comprising:
an interior region for receiving a substance; and
a wall at least partially defining the interior region, the wall including an outer surface and an opposite inner surface disposed between the outer surface and the interior region of the container, the wall including a first thermal conduction path extending between the inner and outer surfaces, and a second thermal conduction path arranged adjacent the first thermal conduction path and extending between the inner and outer surfaces, wherein the first thermal conduction path has a higher effective thermal conductivity than the second thermal conduction path.

2. The container of claim 1, wherein the first thermal conduction path includes a first material having a first thermal conductivity, and the second thermal conduction path includes the first material and a second material having a second thermal conductivity, wherein the first thermal conductivity is greater than the second thermal conductivity.

3. The container of claim 2 further comprising multiple first thermal conduction paths and multiple second thermal conduction paths, wherein adjacent second thermal conduction paths are separated by at least one first thermal conduction path.

4. The container of claim 2, wherein the first material is disposed between the second material and the interior region of the container.

5. The container of claim 4, wherein the second material includes air.

6. The container of claim 1, wherein the second thermal conduction path includes a recessed pocket at least partially defining the outer surface of the wall.

7. The container of claim 1, further comprising an outer material layer disposed adjacent the outer surface of the wall, the wall being disposed between the outer material layer and the inner region of the container, wherein the first and second thermal conduction paths extend through the outer material layer.

8. The container of claim 1, wherein the first and second thermal conduction paths are arranged in a region of the container intended to be grasped by a user.

9. A container comprising:
an interior region for receiving a substance; and
a wall at least partially defining the interior region, the wall including an outer surface, an opposite inner surface disposed between the outer surface and the interior region of the container, and at least one recessed pocket at least partially defining the outer surface of the wall, wherein the at least one recessed pocket is arranged in a region of the container intended to be grasped by a user.

10. The container of claim 9, wherein the at least one recessed pocket defines a first thermal conduction path having a first effective thermal conductivity, and a region of the wall adjacent the at least one recessed pocket defines a second effective thermal conduction path having a second effective thermal conductivity, the second effective thermal conductivity being greater than the first effective thermal conductivity.

11. The container of claim 10, wherein the first thermal conduction path includes a first material having a first thermal conductivity and a second material having a second thermal conductivity, the second thermal conductivity being greater than the first thermal conductivity.

12. The container of claim 11, wherein the second material is disposed between the first material and the interior region of the container.

13. The container of claim 11, wherein the second material is disposed within the at least one recessed pocket.

14. The container of claim 13, where the second material includes air.

15. The container of claim 9, wherein at least a portion of the at least one recessed pocket does not contact any portion of a user's person when the container is grasped by the user in the region of the at least one recessed pocket.

16. The container of claim 15, wherein the at least one recessed pocket forms an air pocket between the user's person and the outer surface of the wall when the container is grasped by the user.

17. The container of claim 9, further comprising an outer material layer disposed adjacent the at least one recessed pocket, the wall being disposed between the outer material layer and the inner region of the container.

18. The container of claim 17, wherein at least a portion of the at least one recessed pocket is disposed away from the outer material layer.

19. A method of heating a substance contained within a microwavable container, the method comprising:
placing the microwavable container including the substance to be heated into a microwave oven, the microwavable container including an interior region for receiving the substance and a wall at least partially defining the interior region, the wall including an outer surface and an opposite inner surface disposed between the outer surface and the interior region of the container, the wall including a first thermal conduction path extending between the inner and outer surfaces, and a second thermal conduction path arranged adjacent the first thermal conduction path and extending between the inner and outer surfaces, wherein the first thermal conduction path has a higher effective thermal conductivity than the second thermal conduction path;
operating the microwave oven to heat the substance, the heating causing the substance to transition from a first consistency prior to being placed in the microwave oven, to a second consistency after heating, the second consistency being less viscous than the first consistency; and
removing the container and heated substance from the microwave oven by grasping the container such that at least a portion of a persons hand overlays the first and second conduction paths.

20. The method of claim 19, wherein the second conduction path includes at least one recessed pocket at least partially defining the outer surface of the wall, the recessed pocket configured to substantially prevent a person's hand from contacting at least the portion of the outer wall defining the recessed pocket when grasping the container with sufficient pressure to maintain a hold on the container.

21. The method of claim 20, wherein the container further includes an outer material layer disposed adjacent the at least one recessed pocket, the wall being disposed between the outer material layer and the inner region of the container, and wherein grasping the container to remove the container and heated substance from the microwave oven includes contacting the outer material layer with at least a portion of the person's hand.

22. The method of claim 19, wherein a temperature of the outer surface of the container wall is perceived by a person grasping the container in the region of the first and second conduction paths to be less than an actual temperature of the outer wall over the same region.

23. The method of claim 19, wherein heating the substance within the microwave oven further comprises increasing a temperature of the substance present within the interior region of the container from a first temperature corresponding to the first consistency to a second temperature corresponding to the second consistency, the second temperature being higher than the first temperature.
